(19) United States
(12) Patent Application Publication
(10) Pub. No.: US 2015/0125830 A1
(43) Pub. Date: May 7, 2015

(54) METHOD AND SYSTEM FOR GENERATING A METRIC OF HOROSCOPE COMPATIBILITY, AND GENERATING A SEQUENCE OF AUDIO AND/OR VISUAL ELEMENTS REPRESENTATIVE OF THE METRIC

(71) Applicant: Stephen Armstrong Saway, New York, NY (US)

(72) Inventor: Stephen Armstrong Saway, New York, NY (US)

(21) Appl. No.: 14/071,846

(22) Filed: Nov. 5, 2013

(51) Int. Cl. G09B 19/00; G09B 5/02; G09B 5/04

(52) U.S. Cl. CPC G09B 19/00; G09B 5/04; G09B 5/02
USPC 434/106

(57) ABSTRACT

The invention provides a method and system for generating a personalized horoscope compatibility metric. The method comprises the steps of receiving user information including an astrological sign corresponding to a user, and generating a perceptible horoscope compatibility metric based on the user information. The invention permits one to perceive a horoscope compatibility metric through a combination of one or more auditory or visual stimuli. Thus, the invention enhances the perception and understanding of horoscope compatibility.

### BACKGROUND

1. Field

This application relates to the field of computer-aided generation of an indicator of horoscope compatibility. More specifically, the present application relates to a method of generating a unique sequence of sounds, colors and/or other audio/visual indicators to enable a person to perceive an estimate of compatibility of horoscope signs, e.g., with respect to a calendar date, a planetary body position, and/or a horoscope profile of another person. With this method and its corresponding system, a person is able to derive enhanced understanding and enjoyment of personalized horoscope compatibility readings.

2. Description of Related Art

Throughout the history of human civilization, astronomers have relied on the movement of celestial bodies across the sky to guide their behavior. Voyagers use constellations to map and guide their journeys, whereas astrologers use the position of celestial bodies to predict and interpret significant events in human history.

The study of the horoscope is based on the theory that every individual's destiny is influenced by a combination of the location, time, and relative alignment of celestial bodies at the time of the person's birth. Different cultures have developed extensive systems of explaining and predicting significant events for an individual based on the interplay of aforementioned factors. The divination of this predestination is often guided by a horoscope chart.

Horoscope predictions gained increasing popularity with the advent of periodicals such as newspapers and magazines. Typically, these daily or monthly horoscopes are generic advices or predictions tailored to a reader's calendar birth date.

With the advent of personal computers and the Internet, comprehensive methods for charting horoscope signs are available and accessible to interested individuals; see, e.g., U.S. Pat. No. 7,357,638 and related applications, whose teachings and methods are incorporated by reference in their entirety. Internet users are able to access websites such as Astrology.com to obtain personalized guidance and predictions based on a user's personalized horoscope chart.

Many cultures believe that the selection of a compatible marriage or romantic partner is a very important decision that should not be left to the fickleness of human attraction and romantic sentiments, but to be guided and confirmed by careful calibrations and matching of various traits such as socio-economic status, personality, interest, and horoscope compatibility. The practice of matchmaking persists to this day, and gains increasing popularity with online dating and social networking websites such as eHarmony.com, Match.com and OKcupid.com. The subscribers for these sites could find romantic matches based on proprietary interpersonal matching systems, or subscriber selectable traits such as geographical location, music preference, political affiliations, and not the least, horoscope compatibility. Compatibility determinations are based on a pre-determined metric or scale, usually delivered and represented in written form.

However, the understanding and perception of compatibility is not only communicated by words, but also perceived by other senses. For example, it is within most people's understanding that music could be understood or described in terms such as happy (e.g., a polka), sad (e.g., a funeral march), and excited (e.g., a John Phillip Sousa march). Similarly, colors could also be imbued with different interpretative meanings, such as “red hot”, “sunny yellow”, or “moody blues”.

Astute observers have noted the parallelism between the horoscope chart and the “circle of fifths” concept in Western music, whereby the circular horoscopic chart could be overlayed on the musical chart. The compatibility between the horoscope signs could be represented in musical form. Examples could be found in the following: http://www.danacataloano.com/music.htm, or www.youtube.com/watch?v=nh3ugoXT17E. However, the parallelism explained in the above examples is static in nature, whereby musical harmony or pitches remain constant within the horoscope chart.

It would therefore be desirable to provide a measure of compatibility of one or more horoscope signs (e.g., corresponding to one or more person's birth date and/or birth place) by generating a unique sequence of sounds such as musical notes. Those person(s) would then be able to hear, for example, concordant or discordant sounds or music, and aurally perceive the compatibility of their respective horoscope signs—and perceive horoscope compatibility.

Similarly, a horoscope chart could be overlayed on a color wheel that represents an arrangement of complementary or clashing color pairings. In this scheme, horoscope compatibility could be perceived by the measure of chromatic harmony. Therefore, it would be desirable to provide a measure of horoscope compatibility based on the generation of a unique sequence of colors, to permit persons to visually perceive that compatibility. In addition, the musical notes and color can be generated together to allow horoscope compatibility to be perceived both aurally and visually.

### SUMMARY

An objective of the present application is to provide a method to enhance a person's ability to perceive horoscope compatibility through a combination of audio and/or visual elements.

The example embodiments herein provide methods, systems, and computer program products for providing a perceptible horoscope compatibility metric. In one example, the method includes receiving user information to compile a horoscope profile comprising at least one astrological sign corresponding to a user. The example embodiment further involves the step of generating a perceptible measure or metric of horoscope compatibility based on the user information.

In accordance with one example, the method of generating horoscope compatibility involves utilizing a horoscope chart that associates horoscope signs with musical notes and/or color.

Musical notes and/or color are outputted to permit perception of the horoscope compatibility metric.

Another exemplary embodiment includes matching a horoscope sign to a corresponding musical note based on a horoscope compatibility chart, and utilizing a random music generator to generate a unique musical sequence.

Once a unique musical sequence is obtained, a further exemplary embodiment includes accessing a musical database (e.g., a collection of music files stored on a local device, or an internet music database) to identify a song that matches the unique musical sequence.

In another exemplary embodiment, the matching of the song in the musical database may be restricted to one or more categories (e.g., based on musical genre, artists, etc.) selectable by the user.

Still a further exemplary embodiment includes synchronizing the musical notes, color and/or visual element such as a graphical sequence or a spectrogram. A spectogram is a graphical representation of a change or variation in frequency with another variable, such as time. The graphical sequence may be depicted in two-dimensional form (e.g., frequency depicted in the y-axis and time depicted in the x-axis), or three-dimensional form (e.g., when a third factor, such as amplitude, is also depicted).

### BRIEF DESCRIPTION OF THE DRAWINGS

The features and advantages of the example embodiments presented herein will become more apparent from the detailed description set forth below when taken in conjunction with the drawings.

FIG. 1 is a representative flowchart illustrating a method of generating and outputting horoscope compatibility metric, in accordance with an example embodiment herein.

FIG. 2 is a representative user interface for receiving one or more items of user information or horoscope signs, and/or generating a musical sequence reflecting a horoscope compatibility metric.

FIG. 3 is a representative horoscope compatibility chart showing an illustration of astrological signs overlaid on the circle of fifth musical system and a color wheel.

FIG. 4 is a representative horoscope compatibility chart showing an illustration of astrological signs overlaid on the circle of fifth musical system and a color wheel.

FIG. 5 is a representative horoscope compatibility chart showing an illustration of astrological signs overlaid on the chromatic scale musical system and a color wheel.

FIG. 6 shows a representative excerpted line-feed musical notation of a unique musical sequence representing musical compatibility metrics between astrological signs.

FIG. 7 is a representative grid diagram reflecting the relationship between Chinese zodiac signs, and musical notes or pitches that are depicted as numerical frequencies.

FIG. 8 is a representative flowchart illustrating an example method of outputting a horoscope compatibility metric by generating musical notes or a unique musical sequence. The unique musical sequence may be outputted, or matched to a song file.

FIG. 9 is a representative excerpted line-feed musical notation system of a unique musical sequence reflecting horoscope compatibility metric between two horoscope profiles.

FIG. 10 is a representative standard musical notation of a unique musical sequence representing a compatibility metric between two horoscope profiles.

FIG. 11 is a representative grid diagram reflecting the relationship between horoscope signs, the chromatic scale musical system and colors.

FIG. 12 is a representative grid diagram reflecting the relationship between Chinese zodiac signs, the chromatic scale musical system and colors.

FIG. 13 is a representative graphic display of a spectrogram generated to convey a horoscope compatibility metric of two horoscope profiles.

FIG. 14 is a block diagram of a device that may be employed in accordance with some of the example embodiments herein.

### DETAILED DESCRIPTION

The exemplary embodiments described herein are intended to explain known methods of practicing the invention and to enable others to utilize the invention in these or other embodiments, with various modifications required by the particular applications of this invention.

The description is not intended to limit the invention to the form disclosed. It should be understood that various modifications can be made to the embodiments disclosed herein, without departing from the scope of the invention or without loss of its advantages. Thus, variations and modifications applying the principles described herein are intended to fall within the scope of the invention.

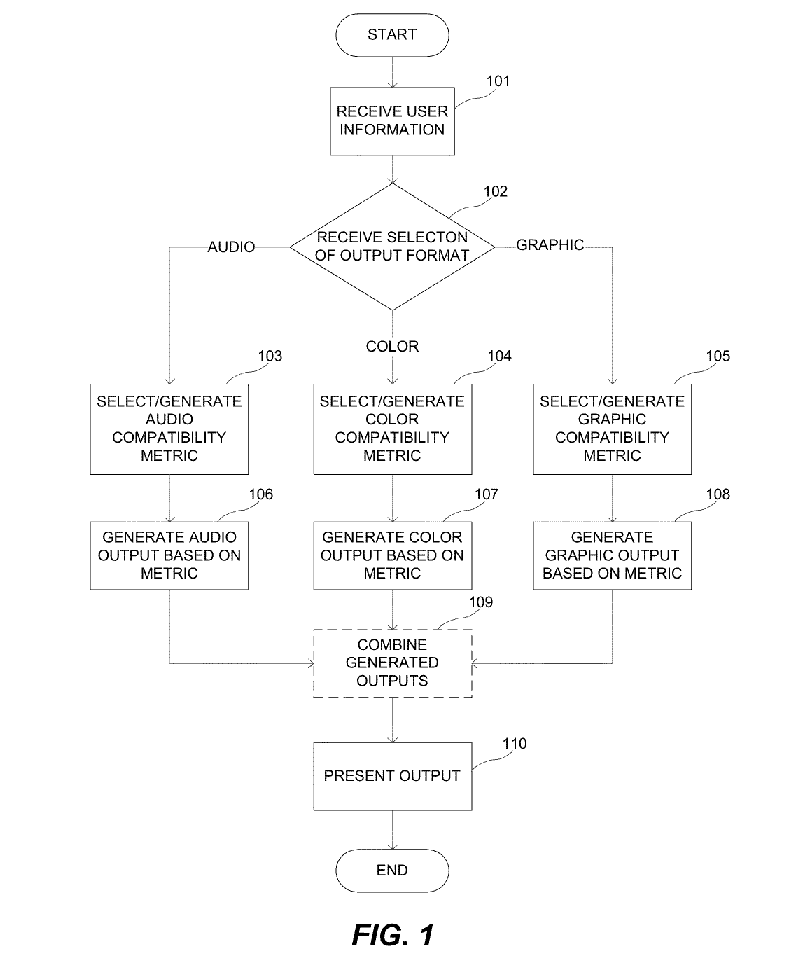

FIG. 1 is a representative flowchart illustrating a method of generating a metric of horoscope compatibility in accordance with an example embodiment herein.

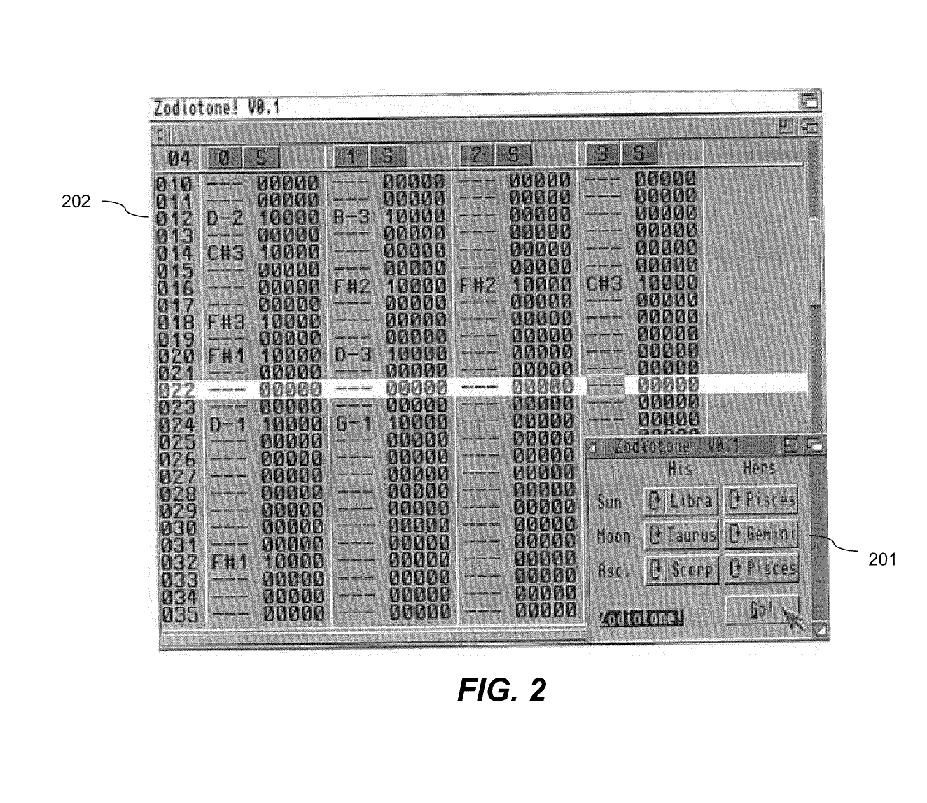

In one example embodiment, the method exemplified in FIG. 1 may be implemented as a software application or an applet, whereby a user interface (e.g. a user interface to implement the method 101 described in FIG. 2. below) is provided that enables one or more items of user information of one individual to be entered (e.g., to generate a personal horoscope profile or chart).

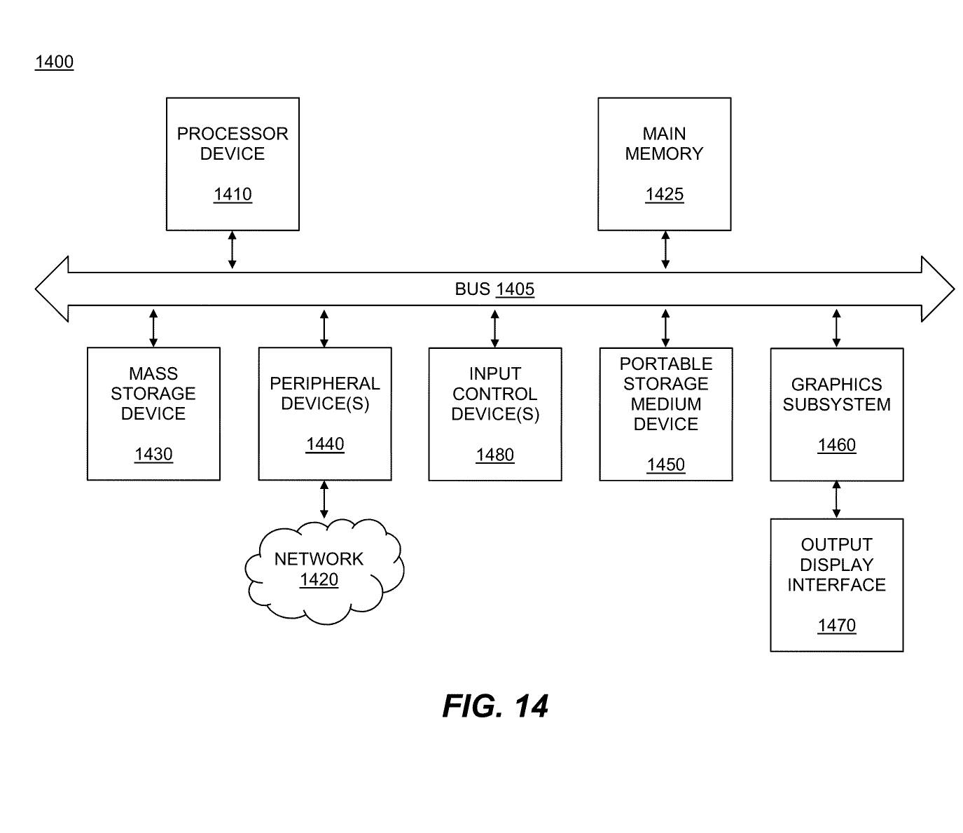

In one example embodiment, the method exemplified in FIG. 1 may be implemented by a processor (e.g., the processor 1410 described below in the context of FIG. 14).

In one example embodiment, a step 101 of receiving user information is achieved by first receiving one or more items of information. Items of personal information may be received, in one example embodiment, via a user interface (e.g., the user interface shown in FIG. 2). Example items of user information that may be received at block 101 include (1) a birth date of an individual; (2) a birth location (e.g., city, country, latitude/longitude coordinates of an individual, or (3) a birth time (e.g., hours, minutes, and or seconds) of an individual, or (4) one or more astrological signs (e.g., astrological signs corresponding to, e.g. sun, moon and ascendant in the example shown in element 201 of FIG. 2).

In one example embodiment, the items of user information are processed to generate one or more horoscope profile(s), which in some exemplary embodiments herein is stored at least temporarily in a main memory, or in a portable storage medium device (e.g., the main memory 1425, or portable storage medium device 1450, described below in the context of FIG. 14).

An exemplary method for generating a horoscope profile is described in U.S. Pat. No. 7,357,638, which is hereby incorporated in its entirety by reference. For example, a horoscope profile may take the form of a database entry, including each of the items of information received, and stored in connection with an identifier of a corresponding individual.

Once a horoscope profile or chart is generated, a horoscope compatibility metric in relation to a calendar date, a planetary body position, or another horoscope profile can then be generated.

In accordance with an exemplary embodiment herein, the user interface enables the user to select at block 102, at least one output format to represent the compatibility metric. In another exemplary embodiment, the user interface additionally provides for the selection of a horoscope system (e.g., Western Horoscope, Chinese Zodiac, Indian Zodiac etc.).

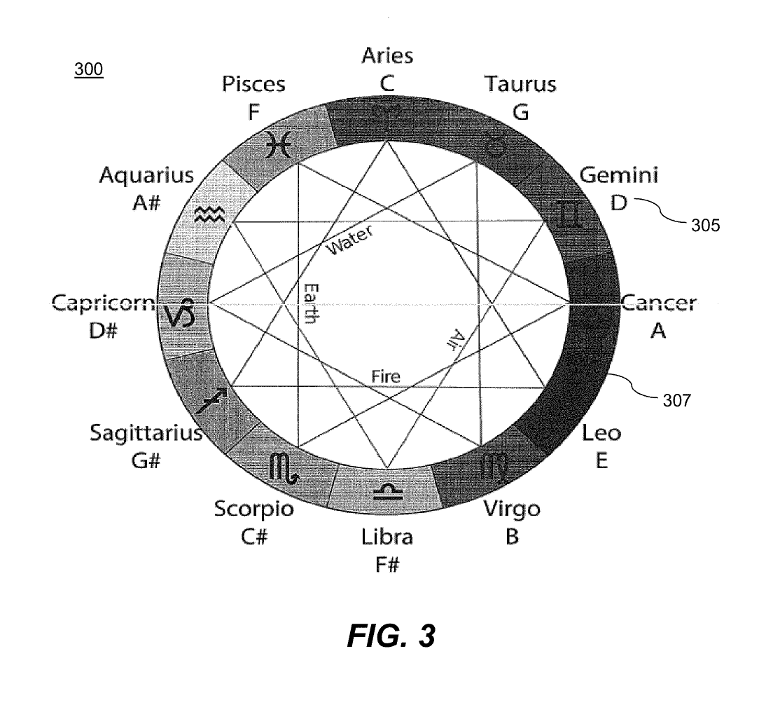

If an audio output is selected at block 102, the user may perceive musical notes conveying the compatibility metric of the horoscope profile(s) entered. In one example, the user may select at block 103, an audio compatibility metric (e.g., as shown in FIGS. 3 through 7), upon which to generate an audio output. Alternatively, the audio compatibility metric may be pre-generated. Musical notes or a unique musical sequence may be generated (e.g., exemplary embodiments are depicted in FIGS. 2, 3, 6, 9 and 10) based on the horoscope compatibility metric. The musical notes may be stored in a memory, and/or output (block 110), either individually (block 106), or combined (block 109) with a color and/or graphical representation of the compatibility metric.

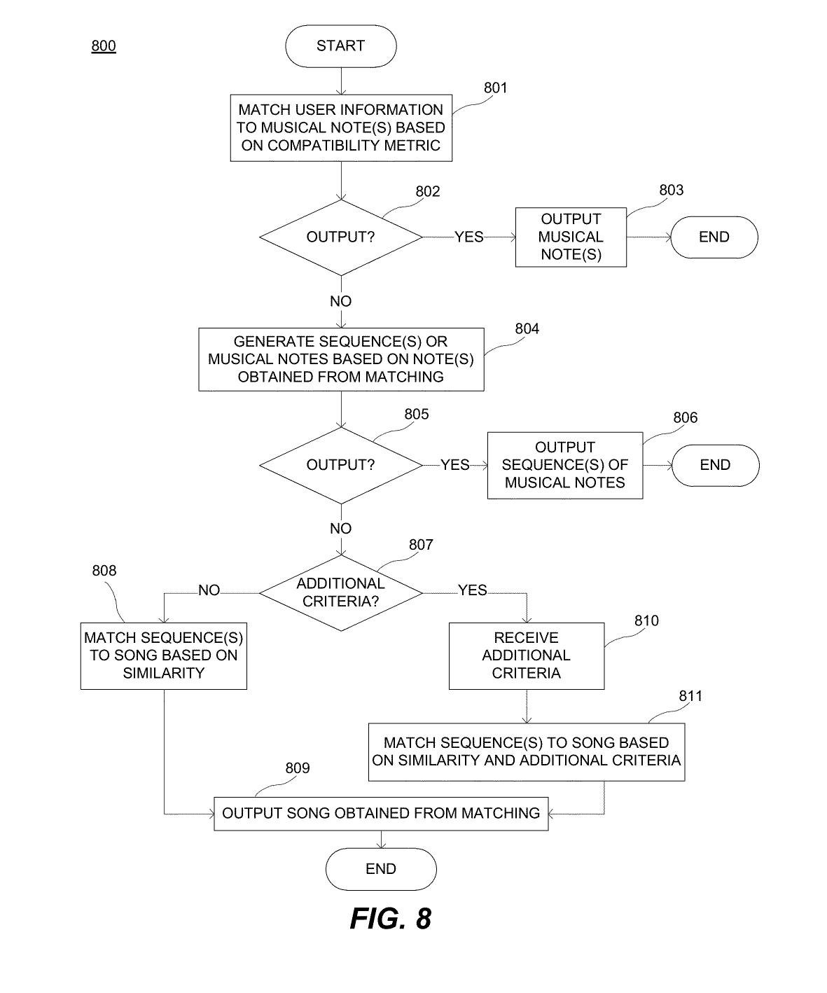

Further example aspects for selecting and/or generating musical notes/unique musical sequence are described below in the context of FIG. 8. In another example embodiment of the invention, the output or display of the unique sequence could also be further selectable to accommodate choices of volume, frequency, duration of unique sequence; choice of visual and/or audio display; source of the unique sequence (either from a personal playlist or a musical database, music genre, etc.), time and repetition of display (e.g., in conjunction with an alarm function, or snooze function).

If a color output is selected at block 102, in one example, the user may select at block 104, a color compatibility metric (e.g., as shown in FIGS. 3-5, 11, and 12), upon which to generate color output. Alternatively, the color compatibility metric may be pre-generated. A color or a unique color combination may be generated at block 107 (e.g., exemplary embodiments are depicted in FIGS. 3-5, 11 and 12), based on the compatibility metric. In one example, the color output is generated by combining a color associated with a first user (from the information received at block 101) and a color associated with a second user. The color combination may be stored in a memory, and/or output (block 110), either individually (block 107), as combined (block 109) with an audio and/or a graphical representation of the compatibility metric.

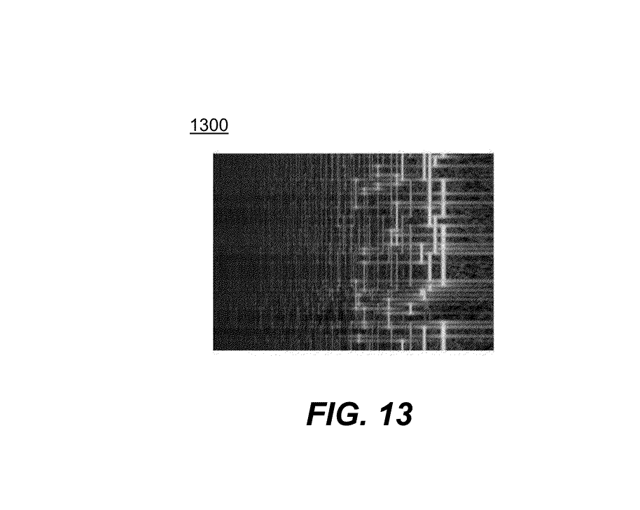

If a graphic output is selected at block 102, in one example, a graphic compatibilty metric may be selected and/or generated at block 105. A graphic or a unique graphical sequence may be generated at block 108, (e.g., exemplary embodiments are depicted in FIG. 13) based on the compatibility metric. The graphical combination may be stored in a memory, and/or output (block 110), either individually (block 108), or combined (block 109) with an audio and/or color representation of the compatibility metric.

One example of a graphical output is shown in FIG. 13, which shows a spectrogram embodying a graphical visualization of a compatibility metric between two horoscope profiles. In one example, the spectrogram is generated (block 108) based on an audio output previously generated (block 106).

In another example embodiment of the invention, the graphical display may comprise a picture, sign, geometrical shapes, pictorial drawing, emoticons (examples of which are listed on http://en.wikipedia.org/wiki/Emoticons, accessed Jul. 18, 2013), or stick figures denoting the compatibility metric of the horoscope profiles. The graphical display may be generated randomly or assigned to a certain horoscope compatibility metric (e.g., a sad emoticon signifying a low horoscope compatibility index, hearts and flowers representing a high horoscope compatibility metric, etc.).

In yet another example embodiment, the graphical display could be static or moving (e.g., a flashing smiling emoticon, a ticker board-type display of two stick figures running towards such other, etc.).

In another example embodiment of the invention, a synchronization step synchronizes rhythms, pitch, colorimetric and graphical changes in the perceptible compatibility metric, before outputting at block 110.

In one exemplary embodiment, the compatibility metric generated in the procedure of FIG. 1 can be stored at least temporarily in a main memory or in a portable storage medium device (e.g., the main memory 1425, or portable storage medium device 1450, described below in the context of FIG. 14).

In another exemplary embodiment, the compatibility metric generated in the procedure of FIG. 1 can be presented through an output device (e.g., the output display interface 1470, described below in the context of FIG. 14).

FIG. 2 is an exemplary embodiment of a user interface 201, for receiving user information corresponding to a user to generate a horoscope profile.

In the exemplary embodiment represented in FIG. 2, audio output (e.g., a unique musical sequence) is selected at block 102 (FIG. 1). A unique musical sequence representing a compatibility metric is represented in position 202 of FIG. 2, as four horizontal musical tracks (i.e., 0S-3S) outputted sequentially (e.g., lines 010-035).

FIG. 3 is an example horoscope chart 300, reflecting the harmony or dissonance between horoscope signs, a musical system 305, and a color wheel 307 (represented in grayscale) that would be reflected by a horoscope compatibility metric.

In this exemplary embodiment, the astrological signs are assigned to musical notes on a musical system (e.g., a circle of fifths system) and colors (e.g., a Newton color wheel). Therefore, the interrelationship between the astrological signs can be displayed as harmony or dissonance of musical notes and/or color.

FIG. 3 also illustrates an exemplary relationship between two horoscope signs, represented by musical intervals. For example, the relationship between the astrology signs Gemini and Leo, is represented by the interval between two musical notes, D 305 and E 307.

A further representation of a horoscope compatibility metric may be expressed in a music sequence represented by characteristics such as consonance, dissonance, harmony, melody or other perceptual characteristics of musical sequences such as tone, pitch, pace, melody, etc.

In the embodiment represented in FIG. 3, the twelve signs of the Western horoscope system are assigned to the twelve-tone system as represented by the “circle of fifths” chart of the Western classical music system. It is understood that other horoscope and musical systems exist. Such systems include the Chinese zodiac system, based on the lunar calendar, or the Indian zodiac system. A diversity of musical styles and systems exists based on different scales, harmonies and modes (e.g., pentatonic scales, world music, Indian classical music, etc.). It is within the embodiments of this invention that the horoscope and musical system used in the invention is selectable to cater to the preference of the adherents and practitioners of these alternate horoscope and/or musical systems.

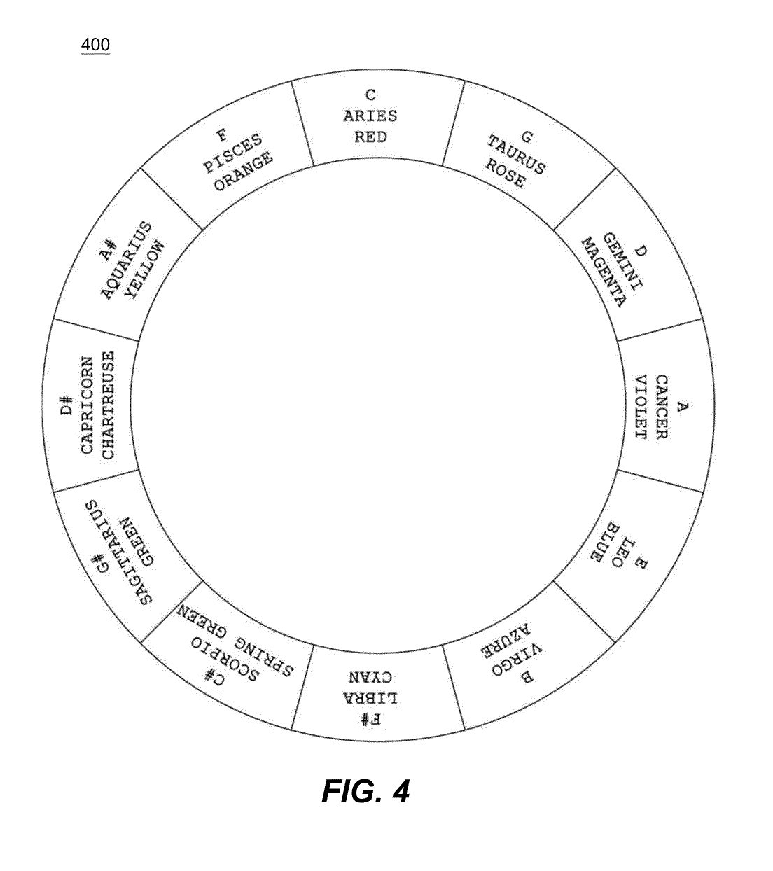

It is also within the embodiments of this invention that the color wheel used in the invention is selectable to cater to the preference of the user 400, FIG. 4. The user may choose a different color wheel or specify a preferred color for a horoscope sign (against which the rest of the colors from the color wheel will be aligned). In the exemplary embodiment in FIG. 4, for instance, the user specified that the Aries astrological sign corresponds to the color red.

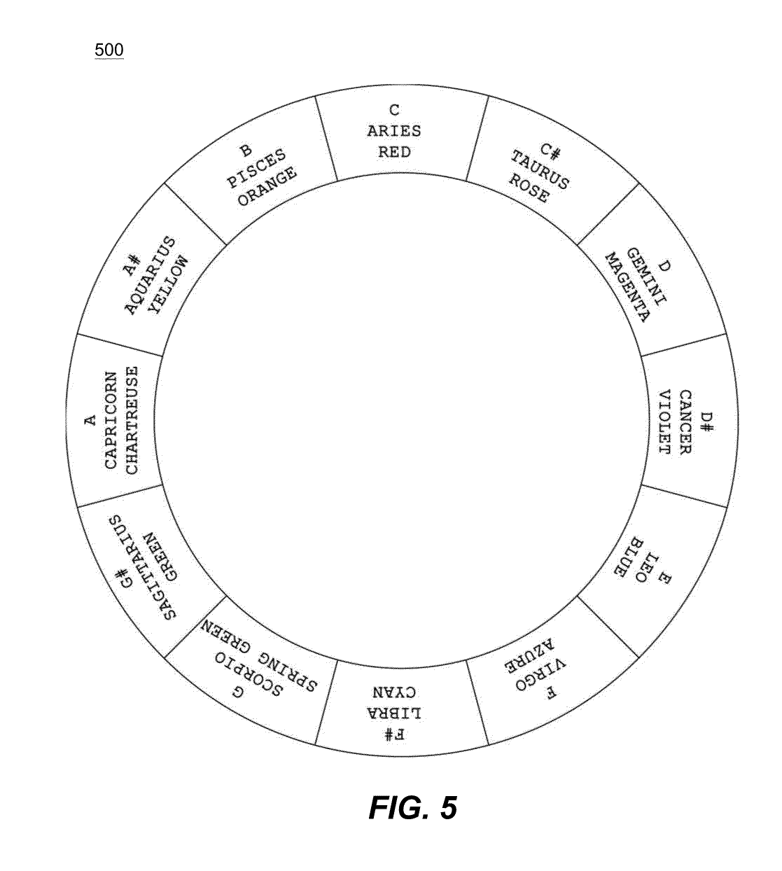

FIG. 5 is yet another example diagram 500 that reflects the relationship between astrological signs, a musical system represented by the chromatic scale progression (instead of the circle of fifth system as depicted in FIGS. 3 and 5), and a color wheel.

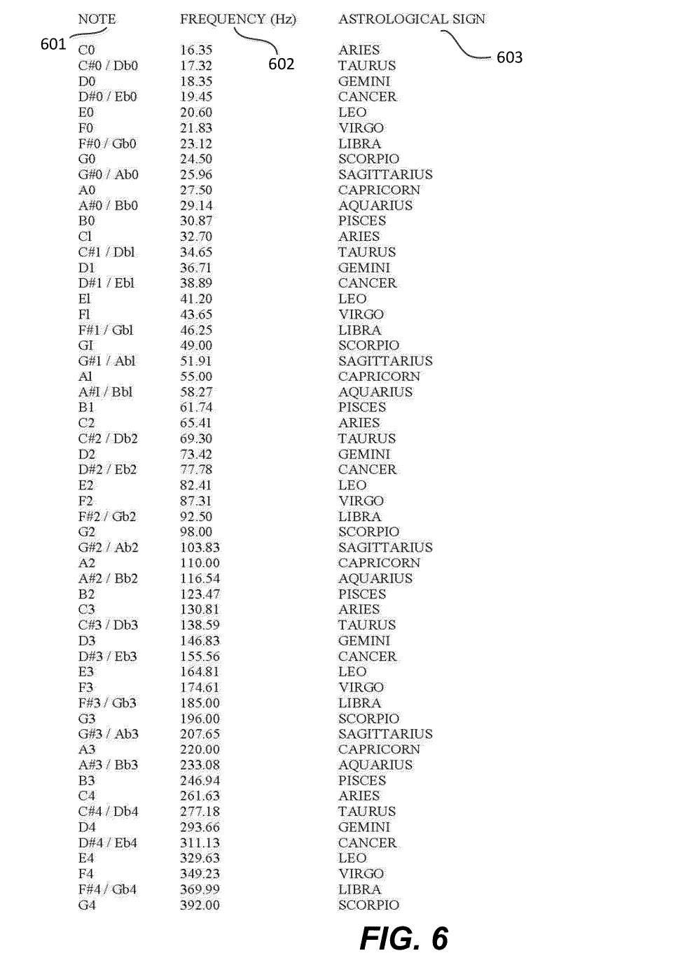

In another exemplary embodiment as depicted in FIG. 6, the musical notes 601 for reflecting compatibility of astrological signs 603 are represented by corresponding audio frequencies 602.

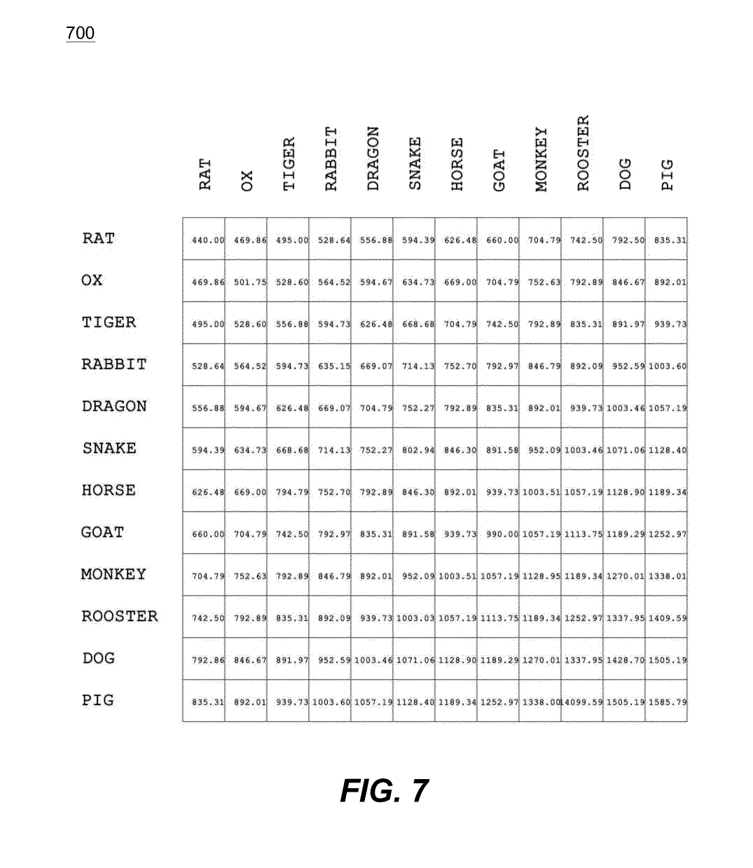

FIG. 7 is an exemplary grid diagram 700 illustrating the relationship between horoscope signs and the related audio output. In this exemplary embodiment, the musical notes corresponding to the compatibility of horoscope signs (i.e., depicted in this exemplary embodiment as Chinese zodiac signs) are represented in the grid diagram as numerical frequencies. As an example, the intersection of the Ox and Tiger zodiac signs would generate a musical note with a frequency of 528.6 Hz, whereas the combination of the Dog and Rooster zodiac signs would generate musical note with a frequency of 1337.95 Hz.

FIG. 8 is an example flow chart 800, illustrating a method for generating and outputting unique musical sequences to reflect horoscope a compatibility metric. In one example, the procedure of FIG. 8 further represents the procedure 106 (FIG. 1). In one example embodiment, the user information received at block 101 may be used at block 801 to generate musical notes according to a horoscope compability chart (e.g., the horoscope charts described in exemplary embodiments represented by FIGS. 3-7). A user selection 802 would determine if the musical notes would be outputted at block 803, or further processed.

If the user has not decided to output the musical sequence at this stage (“No” at block 802) then, in one example embodiment, a random music generation algorithm uses the musical notes obtained in 801 to generate at block 804 a unique musical sequence. At block 805, the user selects whether to output the musical notes at block 806, or continutes the process.

If the user has not decided to output the musical sequence at this stage (“no” at block 805), then in another further example embodiment, a user selects at block 807 whether to use any additional criteria for matching the music sequence to a song. If the user does not wish to use any additional criteria (“no” at block 807), then the procedure progresses to block 808. If “yes” is selected at block 807, then the procedure progresses to block 810.

At block 808, the unique musical sequence generated at block 804 is matched by a processor (e.g., the processor 1410 described below in the context of FIG. 14) to a song contained in song files (block 808). The matched song may be outputted at block 809 upon selection by the user.

In another further example embodiment at block 810, one or more additional criteria (e.g., genre, artists, etc.) are provided by the user. At block 811, the unique musical sequence generated at block 804 is matched to a song from a music database, wherein the matched song is restricted to match the additional criteria provided at block 810.

There are many music database systems having the function of analyzing, cataloging, indexing and recommending music. Such systems have been described, for example, in U.S. Pat. Nos. 7,081,579; 7,949,649; 8,053,659; and 8,234,284; whose teachings and methods are hereby incorporated by reference herein in their entireties. Methods disclosed within these references include methods to access, process, and analyze music based on parameters such as “acoustic metadata” (i.e., pitches, tempo, structure, harmony, etc.) or “cultural metadata” (genre, text/lyrics, moods, theme, etc.). These teachings further include methods to catalog and index the music, in order to recommend music based on the parameters described above. One embodiment of this invention comprises the additional step of accessing a musical database to search for music files having pre-determined parameters that match the compatibility metric musical sequence generated at block 804, and/or reflect the horoscope compatibility metric. The song may be outputted at block 809 upon selection by the user.

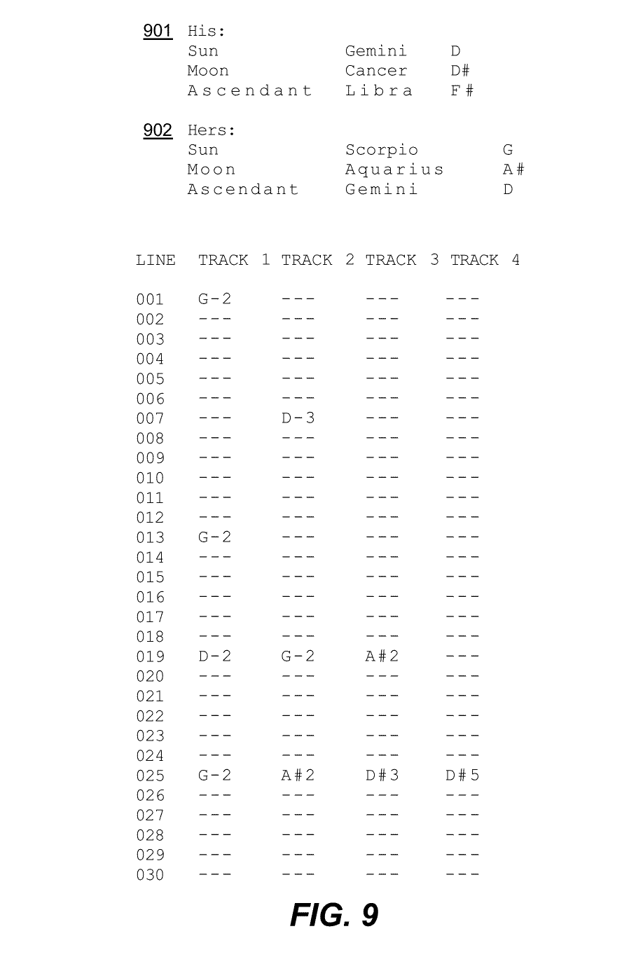

An example embodiment of audio output 106 (such as the audio output that may be generated at block 804 (FIG. 8)), is illustrated in FIG. 9. Three sets of astrological signs corresponding to Sun, Moon and Ascendant signs of two individuals (e.g., His 901 and Hers 902) are received in the user interface (e.g. 201). Once the method is implemented as described in FIG. 1, musical notes representing the relationship are generated and outputted. As depicted in this line-feed musical notation system, four musical tracks (i.e. TRACK 1-TRACK 4), are generated. Musical notes played on each track at any given time are shown on the first column (i.e. LINE), whereupon each line represents a musical quarter note. The combination of alphabets and numbers for a given track and line represents the musical notes and pitches generated (e.g., D#5 is two octaves higher than D#3).

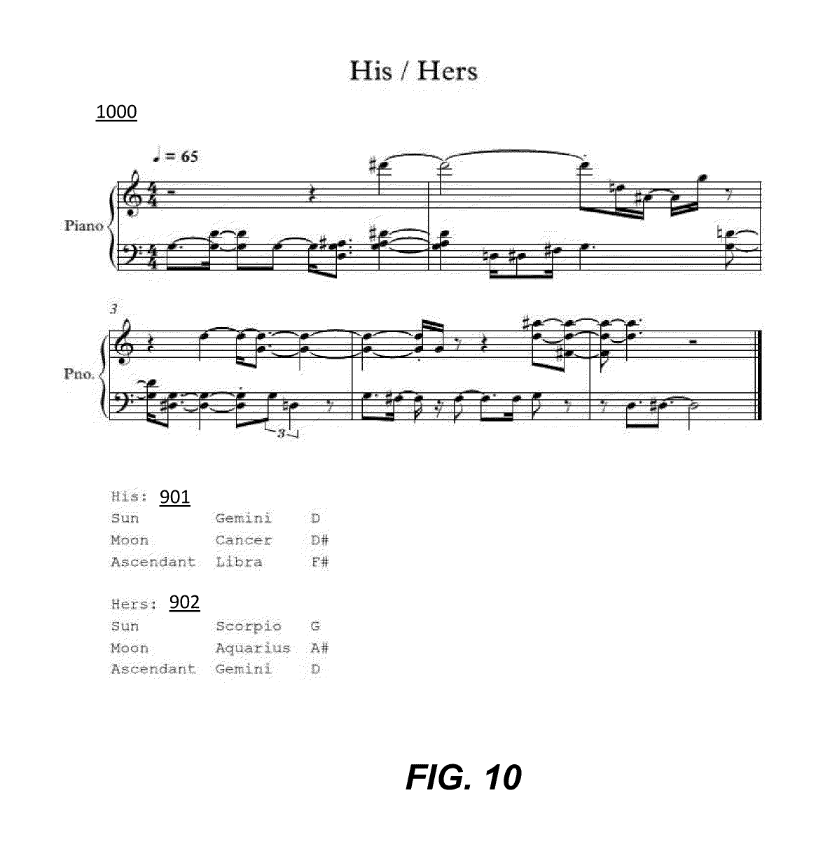

FIG. 10 is a standard musical notation 1000 of the unique musical sequence described in FIG. 9.

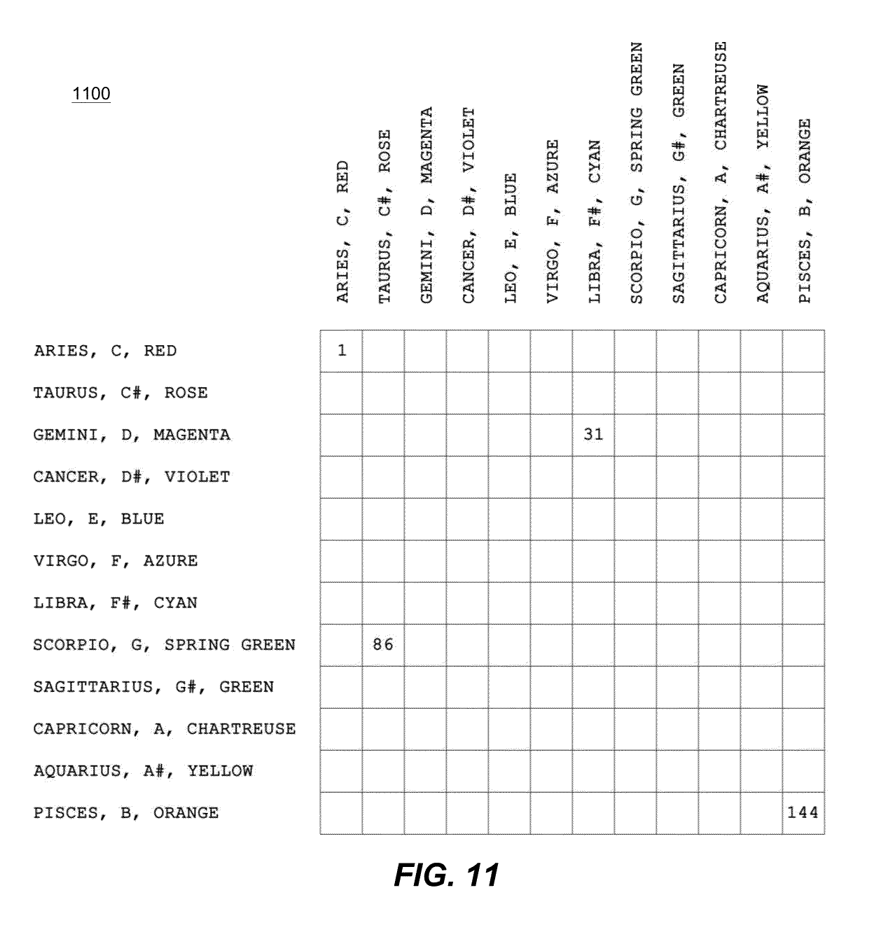

FIG. 11 is an example grid diagram 1100 illustrating the relationship between two horoscope signs and the related audio and color output, which (as described above) may be used at block 107 as a color compatibility metric. As an example, the intersection of the Libra and Gemini horoscope signs in grid # 31 would generate the musical notes of F# and D, with the combination of the colors Cyan and Magenta. Whereas, the combination of the Scorpio and Taurus horoscope signs in grid #86 would generate musical notes C# and G, with the combination of the colors Rose and Spring Green.

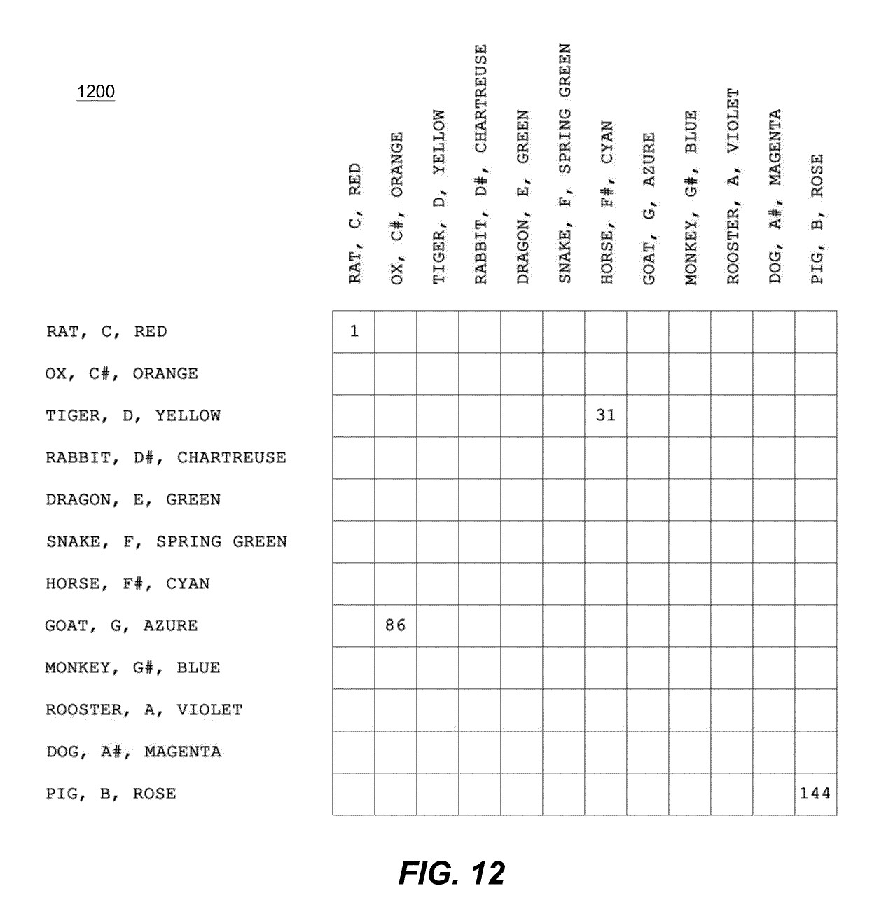

In yet another example grid diagram using a different horoscope system, FIG. 12 represents the relationship between the twelve Chinese zodiac signs with the chromatic scale musical system and a color wheel 1200. As an example, the intersection of the Tiger and Horse horoscope signs in grid # 31 would generate the musical notes of F# and D, with the combination of the colors Cyan and Yellow. Whereas, the combination of the Goat and Ox horoscope signs in grid #86 would generate musical notes C# and G, with the combination of the colors Azure and Orange.

FIG. 13 is an exemplary embodiment of a graphical output 1300 that may be generated to represent a horoscope compatibility metric (e.g., the graphic compatibility metric described above in the context of block 105 of FIG. 1). In this exemplary embodiment, the graphical display is a spectragram.

As can be appreciated in view of the foregoing description, example embodiments as provided enable a person to easily perceive compatibility of one or more horoscope profiles through audio and/or visual elements.

FIG. 14 is a block diagram of a device 1400, which may be a general and/or special purpose computing device, which may be employed in accordance with some of the example embodiments herein, for example, to execute the above-described software application or applet. The device 1400 may be, for example, a user device, a user computer, a client computer and/or a server computer, among other things.

The device 1400 may include without limitation a processor device 1410, a main memory 1425, and an interconnect bus 1405. The processor device 1410 may include without limitation a single microprocessor, or may include a plurality of microprocessors for configuring the device 1400 as a multi-processor system. The main memory 1425 stores, among other things, instructions and/or data for execution by the processor device 1410. The main memory 1425 may include banks of dynamic random access memory (DRAM), as well as cache memory.

The device 1400 may further include a mass storage device 1430, peripheral device(s) 1440, portable storage medium device(s) 1450, input control device(s) 1480, a graphics subsystem 1460, and/or an output display interface 1470. For explanatory purposes, all components in the device 1400 are shown in FIG. 14 as being coupled via the bus 1405. However, the device 1400 is not so limited. Devices of the device 1400 may be coupled via one or more data transport means. For example, the processor device 1410 and/or the main memory 1425 may be coupled via a local microprocessor bus. The mass storage device 1430, peripheral device(s) 1440, portable storage medium device(s) 1450, and/or graphics subsystem 1460 may be coupled via one or more input/output (I/O) buses. The mass storage device 1430 may be a nonvolatile storage device for storing data and/or instructions for use by the processor device 1410. The mass storage device 1430 may be implemented, for example, with a magnetic disk drive or an optical disk drive. In a software embodiment, the mass storage device 1430 is configured for loading contents of the mass storage device 1430 into the main memory 1425.

The portable storage medium device 1450 operates in conjunction with a nonvolatile portable storage medium, such as, for example, a compact disc read only memory (CD-ROM), to input and output data and code to and from the device 1400. In some embodiments, software for storing image data may be stored on a portable storage medium, and may be inputted into the device 1400 via the portable storage medium device 1450. The peripheral device(s) 1440 may include any type of computer support device, such as, for example, an input/output (I/O) interface configured to add additional functionality to the device 1400. For example, the peripheral device(s) 1440 may include a network interface card for interfacing the device 1400 with a network 1420.

The input control device(s) 1480 provide a portion of the user interface for a user of the device 1400. The input control device(s) 1480 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the device 1400 may include the graphics subsystem 1460 and the output display interface 1470. The output display interface 1470 may include hardware for interfacing with a cathode ray tube (CRT) display and/or a liquid crystal display (LCD). The graphics subsystem 1460 receives textual and graphical information, and processes the information for output to the output display interface 1470.

Each component of the device 1400 may represent a broad category of a computer component of a general and/or special purpose computer. Components of the device 1400 are not limited to the specific implementations provided here.

The example embodiments described above such as, for example, the systems and procedures depicted in or discussed in connection with accompanying drawings, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for providing a perceptible measure of horoscope compatibility, the method comprising the steps of:
receiving user information including an astrological sign corresponding to a user; and
generating a perceptible horoscope compatibility metric based on the user information.

2. The method of claim 1, wherein the horoscope compatibility metric is generated based on a horoscope compatibility chart that associates an astrological sign with any one or a combination of corresponding musical note, audible frequency, or color.

3. The method of claim 2, further comprising a step of presenting the perceptible horoscope compatibility metric generated by the generating step.

4. The method of claim 3, wherein presenting the perceptible horoscope compatibility metric includes presenting a sequence of audio elements, one or more visual elements, one or more colors, or a spectrogram corresponding to the sequence of audio elements.

5. The method of claim 2, wherein generating the perceptible horoscope compatibility metric includes the steps of:
matching an astrological sign to one corresponding musical note based on the horoscope compatibility chart; and
generating a sequence of one or more audio elements by initializing a random music generator using musical notes obtained by the matching step.

6. The method of claim 5, wherein generating the perceptible horoscope compatibility metric further includes steps of:
accessing a musical database; and
identifying within the musical database a song that matches the generated sequence of one or more audio elements.

7. The method of claim 6, further including a step of:
receiving from the user a criterion including one or more musical categories, wherein the matched song is identified from within the musical database based on the criterion.

8. The method of claim 2, wherein generating the perceptible horoscope compatibility metric includes the steps of:
matching the astrological sign to a corresponding color based on the horoscope compatibility chart; and
generating one or more visual elements obtained by the matching step.

9. A system for providing a perceptible measure of horoscope compatibility, the system comprising:
an input device for receiving user information, including an astrological sign corresponding to a user;
a memory for storing the received user information; and
a processor coupled to the memory, for generating a perceptible horoscope compatibility metric based on the user information.

10. The system of claim 9, wherein the horoscope compatibility metric includes a horoscope chart that associates the astrological sign with any one or a combination of a corresponding musical note, audible frequency, or color.

11. The system of claim 10, further comprising an output device to output the generated perceptible horoscope compatibility metric.

12. The system of claim 11, wherein the output device outputs a sequence of audio elements, one or more visual elements, one or more colors, or one or more spectrogram corresponding to the sequence of audio elements.

13. The system of claim 10, wherein the processor generates the perceptible horoscope compatibility metric by:
matching the astrological sign to a corresponding musical note based on the horoscope compatibility chart; and
generating a sequence of one or more audio elements by initializing a random music generator using musical notes obtained by the matching.

14. The system of claim 13, wherein the processor generates the perceptible horoscope compatibility metric by:
accessing a musical database; and
identifying within the musical database a song that matches the generated sequence of one or more audio elements.

15. The system of claim 14, wherein the input device receives from the user a criterion including one or more musical categories, wherein the matched song is identified from within the musical database based on the criterion.

16. The system of claim 10, wherein the processor generates the perceptible horoscope compatibility metric by:
matching an astrological sign to a corresponding color based on the horoscope compatibility chart; and
generating one or more visual elements obtained by the matching step.

17. The system of claim 10, wherein the processor uses the horoscope compatibility chart to associate the astrological sign with any one or a combination of a corresponding musical note, audible frequency, or color.

18. The system in claim 11 wherein the output device comprises audio speakers, a display, or both.

19. A non-transitory computer-readable medium having stored thereon sequences of instructions, which, when executed by a computer, causes the computer to perform steps of:
receiving user information including an astrological sign corresponding to a user; and
generating a perceptible horoscope compatibility metric based on the user information.

20. The non-transitory computer-readable medium of claim 19, wherein the sequences of instructions, when executed by the computer, further causes the computer to perform the step of presenting the generated perceptible measure of horoscope compatibility metric.
